(19) United States
(12) Patent Application Publication
(10) Pub. No.: US 2024/0343091 A1
(43) Pub. Date: Oct. 17, 2024

(54) FLUID HEATING DEVICE FOR ELECTRIC VEHICLE

(71) Applicant: KOREA FUEL-TECH CORPORATION, Anseong-si (KR)

(72) Inventors: Ki Hong KIM, Anseong-si (KR); Dong Chul LEE, Hwaseong-si (KR); Seung Jin YANG, Anseong-si (KR)

(21) Appl. No.: 18/606,416

(22) Filed: Mar. 15, 2024

(30) Foreign Application Priority Data
Apr. 17, 2023 (KR) 10-2023-0049879

(51) Int. Cl. B60H 1/22

(52) U.S. Cl. CPC B60H 1/2221; B60H 2001/2271

(57) ABSTRACT

The fluid heating device comprises: a housing forming a first space in which a fluid is introduced and heated, and a second space separated from the first space by a partition wall formed therein; a heater that extends from an outside of the housing into the first space to form a path through which the fluid flows into the first space and heats the fluid; a plate provided on the partition wall between the first space and the second space to be close to the heater; and an overheating prevention unit provided on a side of the plate facing the second space and blocking power provided to the heater when heat applied from the heater reaches a preset range.

### CROSS REFERENCE TO RELATED APPLICATION

This application claims priority from Republic of Korea Patent Application No. 10-2023-0049879, filed on Apr. 17 2023, which is hereby incorporated by reference in its entirety.

### BACKGROUND

### Field

The present disclosure relates to a fluid heating device for an electric vehicle, and more particularly, to a fluid heating device for an electric vehicle for increasing the temperature of a battery of an electric vehicle.

### Related Art

Generally, an electric vehicle runs based on a battery mounted on the vehicle. The performance of the battery may deteriorate when the outside temperature drops. In order to secure the performance of the battery, a battery heating system is required. The heating system heats fluid and uses the heated fluid to increase the temperature of the battery.

A conventional heating device is disclosed in Korean Patent No. 10-1878723 entitled “Heater assembly for heating fluid” (published on Jul. 17, 2018). The conventional heating device includes a housing in which fluid is introduced and from which the fluid is discharged, and a heater for heating the fluid in the housing. The conventional heating device increases the temperature of a battery by providing the heated fluid to the battery.

In the conventional heating device, the heater may overheat when insufficient fluid flows in the housing. In this case, the internal temperature of the heating device may increase rapidly, which may cause the heating device to break and the heating system to lose its function. As a result, the performance of the battery deteriorates.
(Prior Art Document)
(Patent Document)

Korean Patent No. 10-1878723 (entitled “Heater assembly for heating fluid” and published on Jul. 17, 2018)

### SUMMARY

The present disclosure provides a fluid heating device for an electric vehicle in which an overheating prevention means for a heater is disposed close to the heater to prevent overheating of the heater at an accurate temperature.

A fluid heating device for an electric vehicle, in accordance with the present disclosure, comprises: a housing forming a first space in which a fluid is introduced and heated, and a second space separated from the first space by a partition wall formed therein; a heater that extends from an outside of the housing into the first space to form a path through which the fluid flows into the first space and heats the fluid; a plate provided on the partition wall between the first space and the second space to be close to the heater; and an overheating prevention unit provided on a side of the plate facing the second space and blocking power provided to the heater when heat applied from the heater reaches a preset range.

The plate may bring the overheating prevention unit closer to the heater than the partition wall.

The plate may include: a support member contacting one surface of the partition wall in the second space; a connecting member extending from the support member to the first space; and a mounting member provided to the connecting member, wherein a surface of the mounting member facing the heater is closer to the heater than the partition wall, and the overheating prevention unit is mounted on the mounting member, and the plate may block fluid communication between the first space and the second space.

The housing may include: a first outer wall extending from the partition wall; and a first cover member coupled to the first outer wall to close the second space, and the first cover member may include a plate pressing body that is coupled to the first outer wall to press the support member against the partition wall.

The fluid heating device may further comprise a ground screw extending through the first cover member into the second space, wherein the ground screw may include: a head member exposed to an outside of the first cover member and connected to a ground wire; and a thread member extending from the head member, penetrating the first cover member, and contacting a wiring disposed in the second space, and a sealing member may be provided between the first cover member and the thread member.

The heater may include: a tube member including a first tube through which the fluid flows in, and a second tube provided to surround the first tube; a heating member provided between the first tube and the second tube to generate heat; and a heater support member extending from an outer periphery of the tube member to come in surface contact with the housing.

The housing may include a second cover member supporting the heater to the housing, and the second cover member may include a heater pressing body that presses the heater support member against the housing.

The housing may include a second outer wall which extends from one surface of the housing and one end of which extends outward, and the second cover member may include a locking protrusion formed at an edge of a surface where the second outer wall is in contact to surround one end of the second outer wall.

The housing may include a coupling member that surrounds an outer surface of an end of the second outer wall and an outer surface of the locking protrusion when the end of the second outer wall and the locking protrusion are coupled to each other.

The tube member may include a heater outlet through which the fluid flows out into the first space, and the housing may be formed such that an outlet through which the fluid flows out is located at a position where the distance between the heater outlet and the outlet is maximized.

The tube member may be made of ceramic material, and when the heating member generates heat exceeding a preset temperature, at least one of the first tube and the second tube may break to prevent overheating of the heating member.

The fluid heating device may further comprise a temperature sensor installed in the housing to measure a temperature of the fluid in the first space, and the housing may include: a sensor fastening member in communication with the first space to which the temperature sensor is fastened, and a separation prevention member connected to an outer end of the temperature sensor and the sensor fastening member to prevent the temperature sensor from being separated from the sensor fastening member.

According to the present disclosure, by arranging the overheating prevention means close to the heater to minimize the influence of the fluid located between the heater and the overheating prevention means, it is possible to block power to the heater based on the exact temperature of the heater.

The technical effects of the present disclosure as described above are not limited to the effects mentioned above, and other technical effects not mentioned will be clearly understood by those skilled in the art from the following description.

### BRIEF DESCRIPTION OF THE DRAWINGS

FIG. 1 is a perspective view showing a fluid heating device for an electric vehicle according to one embodiment.

FIG. 2 is a cross-sectional view showing the fluid heating device of an electric vehicle taken along line I-I′ of FIG. 1.

FIG. 3 is a cross-sectional view showing the fluid heating device of an electric vehicle cut along the line II-II′ of FIG. 1.

FIG. 4 is an exploded perspective view showing a heater of the fluid heating device for an electric vehicle according to one embodiment.

FIG. 5 is a cross-sectional view showing a part of the fluid heating device for an electric vehicle according to one embodiment.

FIG. 6 is a flowchart showing a method of operating the fluid heating device for an electric vehicle according to one embodiment.

### DESCRIPTION OF EXEMPLARY EMBODIMENTS

Hereinafter, embodiments of the present disclosure will be described in detail with reference to the accompanying drawings. However, the present disclosure is not limited to the embodiments disclosed below and may be implemented in various forms. The embodiments are provided merely to make the description of the present disclosure complete and to fully inform a person of ordinary skill in the art to which the present disclosure pertains of the scope of the present disclosure. The shapes of elements in the drawings may be exaggerated for clearer explanation, and elements indicated with the same reference numerals in the drawings refer to the same elements.

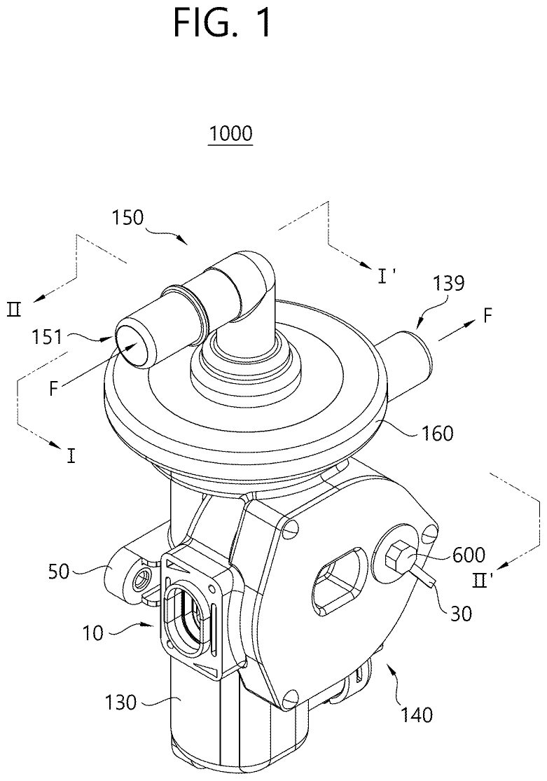

FIG. 1 is a perspective view showing a fluid heating device for an electric vehicle according to one embodiment. As shown in FIG. 1, the fluid heating device 1000 for an electric vehicle (hereinafter, referred to as ‘heating device 1000’) according to the present embodiment is configured to heat fluid F. The fluid F may include coolant used in vehicles. However, the type of fluid F flowing into the heating device 1000 is not limited.

The heating device 1000 forms a space in which the fluid F is accommodated. The heating device 1000 has an inlet 151 through which the fluid F flows in and an outlet 139 through which the fluid F flows out. Further, the heating device 1000 heats the fluid F provided through the inlet 151 based on power provided from the outside.

The heating device 1000 is provided with a power cable receptacle 10 for power supply. The heating device 1000 is connected to a ground wire 30 for allowing leakage current that may occur during operation to flow to the outside. The heating device 1000 is provided with a mounting means 50 for mounting to a vehicle, and can be mounted in the vehicle to heat the fluid F for raising the temperature of a battery.

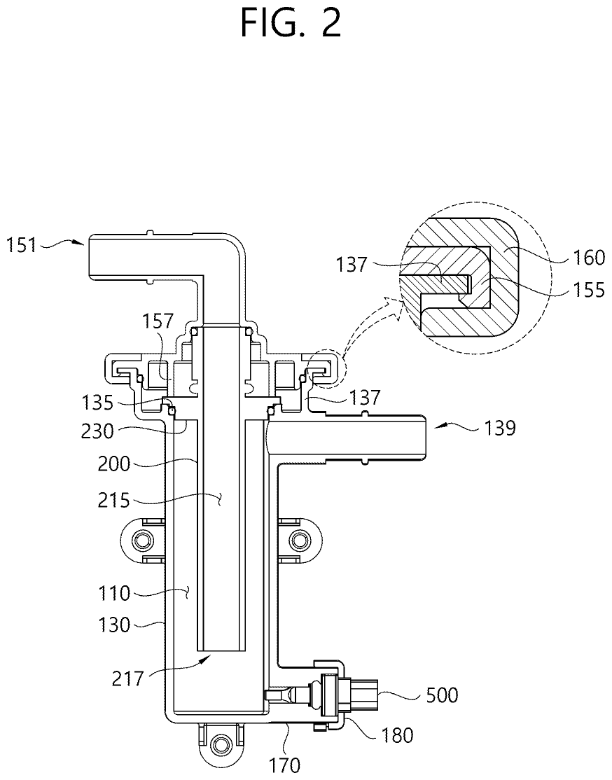

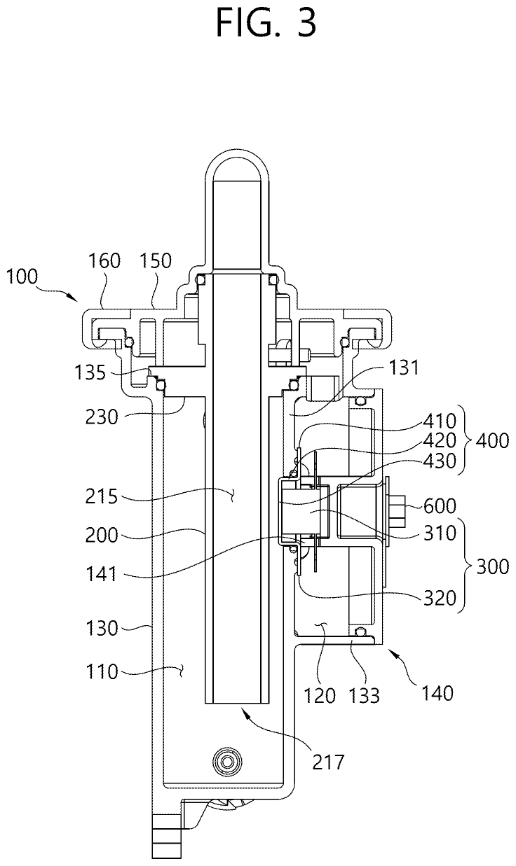

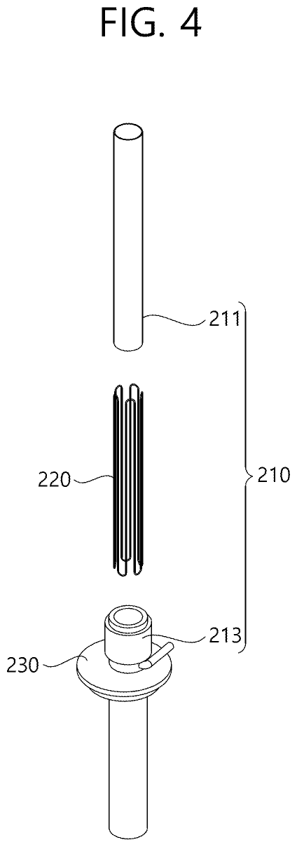

FIG. 2 is a cross-sectional view showing the fluid heating device for an electric vehicle taken along line I-I′ of FIG. 1, and FIG. 3 is a cross-sectional view showing the fluid heating device of an electric vehicle taken along line II-II′ of FIG. 1. Further, FIG. 4 is an exploded perspective view showing a heater of the fluid heating device for an electric vehicle according to the present embodiment.

As shown in FIGS. 2 to 4, the heating device 1000 according to the present embodiment includes a housing 100, a heater 200, an overheating prevention unit 300, a plate 400, a temperature sensor 500, and a ground screw 600.

The housing 100 forms the exterior of the heating device 1000. The housing 100 may be made of a thermoplastic material. The housing 100 forms a first space 110 and a second space 120 therein. The first space 110 is a space in which the fluid F is introduced and heated, and the second space 120 is a space separated from the first space 110.

The housing 100 includes a body 130, a first cover member 140, a second cover member 150, and a coupling member 160.

The body 130 is provided as a cylinder with one side open. The body 130 forms the first space 110 in which the fluid F can be accommodated. The body 130 includes a partition wall 131, a first outer wall 133, a support jaw 135, a second outer wall 137, and an outlet 139.

The partition wall 131 forms an outer peripheral surface of the body 130 and separates the first space 110 and the second space 120. The first outer wall 133 extends outward from the partition wall 131 to form the second space 120 with one side open. The support jaw 135 is formed at one end forming the open side of the body 130. The support jaw 135 supports the heater 200. The second outer wall 137 extends outward from one end of the body 130. Further, the outlet 139 described above is formed on the outer peripheral surface of the body 130 to communicate with the first space 110. In this case, the outlet 139 may be formed in an upper region of the body 130, which will be described later, in order to secure sufficient heating time for the fluid F.

Meanwhile, the first cover member 140 closes the open side of the first outer wall 133. The first cover member 140 is coupled to one end of the first outer wall 133 and can open and close the second space 120. In addition, a sealing member may be provided between the first cover member 140 and the first outer wall 133.

Further, the second cover member 150 is formed with the inlet 151 described above. The second cover member 150 is coupled to one end of the second outer wall 137. In this case, the second cover member 150 has a locking protrusion 155 formed on an edge that contacts the second outer wall 137. The locking protrusion 155 is bent to surround one end of the second outer wall 137. Accordingly, the second cover member 150 is coupled to the body 130 by the engagement of the locking protrusion 155 with the second outer wall 137.

In addition, the coupling member 160 is provided to surround one end of the second outer wall 137 and an outer surface of the locking protrusion 155. The coupling member 160 brings one end of the second outer wall 137 and the locking protrusion 155 into close contact with each other. The coupling member 160 may be formed using an overmolding method to ensure that the body 130 and the second cover member 150 are firmly coupled.

Meanwhile, the heater 200 heats the fluid F flowing into the first space 110. The heater 200 may generate heat based on power provided from the outside. The heater 200 includes a tube member 210, a heating member 220, and a heater support member 230.

The tube member 210 forms an appearance of the heater 200. The tube member 210 communicates with the inlet 151 to form a path through which the fluid F flows into the first space 110. The tube member 210 includes a first tube 211 and a second tube 213. The first tube 211 has an entry path 215 for the fluid F therein. Further, the second tube 213 is provided to surround an outer peripheral surface of the first tube 211. In addition, the tube member 210 is formed with a heater outlet 217 through which the fluid F flows out of the entry path 215 into the first space 110.

The heating member 220 generates heat based on power provided from the outside. The heating member 220 is disposed between the first tube 211 and the second tube 213. In this case, the space between the first tube 211 and the second tube 213 is configured to block fluid communication with the outside to prevent short circuit of the heating member 220.

The heater 200 may be configured to cut off power when overheated. For example, the tube member 210 may be made of a ceramic material. In addition, the first tube 211 and the second tube 213 may be formed to have a predetermined thickness so that they break when the heating member 220 exceeds a preset temperature. The first tube 211 and the second tube 213 of the tube member 210 may have different thicknesses so that at least one of the first tube 211 and the second tube 213 breaks when the heating member 220 generates heat above the preset temperature. The heating member 220 may stop generating heat due to a short circuit or the cut-off of power supply. For example, the heater 200 can be prevented from overheating which may occur when the fluid F introduced in the first space 110 is insufficient.

The heater 200 is disposed on the open side of the body 130. The heater 200 may be supported on the body 130 by the heater support member 230. The heater support member 230 extends from an outer peripheral surface of the tube member 210. The heater support member 230 is supported on the support jaw 135 and closes the open side of the body 130. A sealing member may be provided between the heater support member 230 and the body 130.

Meanwhile, the second cover member 150 described above is provided with a heater pressing body 157 that brings the heater support member 230 into close contact with the body 130. The heater pressing body 157 is provided to press the heater support member 230 when the second cover member 150 is coupled to the second outer wall 137. In this case, the heater pressing body 157 ensures that the body 130 and the second cover member 150, which are coupled by the coupling member 160, are more firmly supported.

Meanwhile, the overheating prevention unit 300 prevents the heater 200 from overheating. The overheating prevention unit 300 may be provided with a thermal fuse. For example, the overheating prevention unit 300 may include a fuse body 310 and a lead wire 320.

The fuse body 310 may have a case made of a ceramic material, and its interior may be filled with a composition containing tungsten. In addition, the lead wire 320 extends from the interior of the fuse body 310 to the outside and may be exposed at both ends of the fuse body 310. Each lead wire 320 exposed at both ends of the fuse body 310 is connected to a wire W that provides power to the heater 200. Further, the lead wire 320 may be physically disconnected when the heat applied to the fuse body 310 exceeds a preset temperature. Accordingly, the overheating prevention unit 300 can block the power provided to the heater 200.

Meanwhile, the plate 400 supports the overheating prevention unit 300. Heat emitted from the heater 200 is applied to the overheating prevention unit 300 through the plate 400. The plate 400 is provided on the partition wall 131 and disposed between the first space 110 and the second space 120. The plate 400 includes a support member 410, a connecting member 420, and a mounting member 430.

The support member 410 may be supported on one surface of the partition wall 131 forming the second space 120. Further, the connecting member 420 extends from the support member 410 to a hole formed in the partition wall 131, and a portion of the connecting member 420 is disposed in the first space 110. The mounting member 430 is provided to the connecting member 420 and disposed in the first space 110. One surface of the mounting member 430 facing the heater 200 may be closer to the heater 200 than the partition wall 131. Further, the overheating prevention unit 300 is mounted on the other surface of the mounting member 430. Accordingly, the overheating prevention unit 300 is adjacent to the heater 200, so that interference with the fluid F can be minimized. In this case, the first cover member 140 is provided with a plate pressing body 141. The plate pressing body 141 extends from the first cover member 140 toward the support member 410 to support the support member 410 in the second space 120.

Meanwhile, the temperature sensor 500 measures the temperature of the fluid F introduced in the first space 110. The temperature sensor 500 may be installed on a sensor fastening body 170 provided on the body 130. In this case, the sensor fastening body 170 allows the first space 110 to communicate with an installation space of the temperature sensor 500 so that the temperature sensor 500 can measure the temperature of the fluid in the first space 110. Accordingly, the temperature sensor 500 can be inserted into the sensor fastening body 170 and measure the temperature of the fluid F in the first space 110 by contacting the fluid F in the first space 110. The temperature sensor 500 may be installed as spaced apart from the heater 200 as possible to minimize interference with heat from the heater 200.

Meanwhile, a separation prevention member 180 may be provided between the sensor fastening body 170 and the temperature sensor 500 to prevent the temperature sensor 500 from being separated. The separation prevention member 180 may be provided as a cap. The separation prevention member 180 is coupled with a coupling protrusion formed on an outer peripheral surface of the sensor fastening body 170 so that the temperature sensor 500 is firmly supported on the sensor fastening body 170.

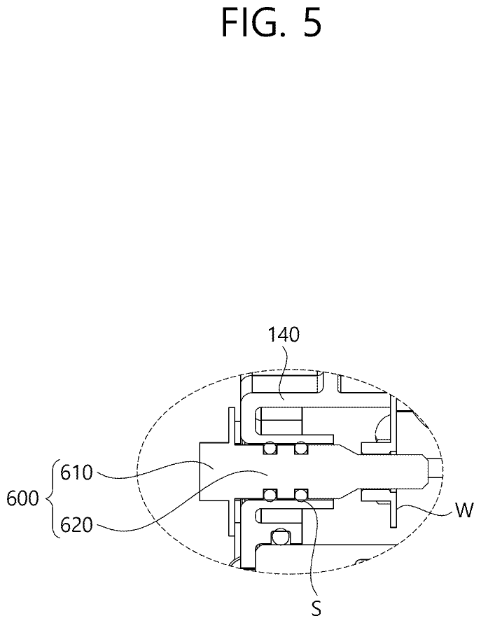

FIG. 5 is a cross-sectional view showing a part of the fluid heating device for an electric vehicle according to the present embodiment.

As shown in FIG. 5, the ground screw 600 according to the present embodiment extends through the first cover member 140 and into the second space 120. The ground screw 600 allows the leakage current occurring in the second space 120 to flow therethrough to the outside. The ground screw 600 includes a head member 610 and a thread member 620.

The head member 610 is exposed to the outside of the first cover member 140 and is connected to a ground wire G. Further, the thread member 620 extends through the first cover member 140 into the second space 120. The thread member 620 may be connected to the wiring W provided in the second space 120. In this case, the wiring W may be a power cable and/or an electrical configuration for application of the overheating prevention unit 300. Accordingly, the ground screw 600 transfers the leakage current that occurs while power is supplied to the heater 200 to the ground wire. The ground screw 600 can prevent electrical leakage in the heating device 1000.

In addition, a sealing member S may be provided between the thread member 620 and the first cover member 140. In this case, one or more sealing members S may be provided. The sealing members S may be spaced apart between the thread member 620 and the first cover member 140. The sealing member S blocks fluid that may flow into the second space 120 from the outside of the heating device 1000. The sealing member S can prevent malfunction of the heating device 1000 by preventing electrical leakage in the electrical components disposed in the second space 120.

Hereinafter, a method of increasing the temperature of the battery using the heating device will be described with reference to the accompanying drawings. However, detailed description of the above-mentioned components will be omitted and they will be described by assigning the same reference numerals.

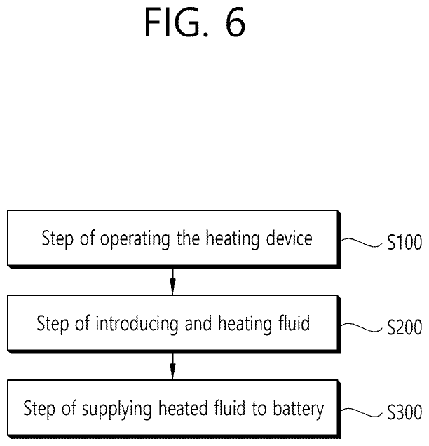

FIG. 6 is a flowchart showing a method of operating the fluid heating device for an electric vehicle according to the present embodiment.

As shown in FIG. 6, the heating device 1000 according to the present embodiment can increase the temperature of the battery through a step of operating the heating device (S100), a step of introducing and heating the fluid (S200), and a step of supplying the heated fluid to the battery (S300).

First, in the step of operating the heating device (S100), the heating device 1000 may be operated when the outside air temperature of the electric vehicle is below a preset temperature.

Then, in the step of introducing and heating the fluid (S200), the fluid (F) flows into the heating device 1000 through the inlet 151. The fluid F flows into the first space 110 through the entry path 215. At this time, the heater 200 generates heat and heats the incoming fluid F.

Meanwhile, the temperature sensor 500 measures the temperature of the fluid F introduced in the first space 110. Then, the temperature sensor 500 provides the measured temperature of the fluid F to a control device that controls heat generation of the vehicle system and/or the heater 200. The fluid F introduced in the first space 110 flows toward the outlet 139. In this case, the heater 200 heats the fluid F in contact with the outer peripheral surface of the tube member 210.

Meanwhile, the overheating prevention unit 300 receives the heat emitted by the heater 200 and blocks the power provided to the heater 200. In this case, the overheating prevention unit 300 is disposed close to the heater 200 so that it can block power based on the exact temperature of heat applied from the heater 200. In addition, when the heating member 220 of the heater 200 generates heat exceeding a preset temperature, the tube member 210 may break and power may be cut off. Accordingly, the heating device 1000 can prevent overheating of the heater 200 due to the configuration of the heater 200 and the overheating prevention unit 300. Further, the heating device 1000 can ensure stability by preventing defects caused by overheating of the heater 200, such as damage to the housing 100 due to heat, in advance.

Then, in the step of supplying the heated fluid to the battery (S300), the fluid F heated by the heating device 1000 flows out through the outlet 139, and the heated fluid F is supplied to the battery of the electric vehicle. Accordingly, the battery can be heated based on the heated fluid F.

In this way, the heating device 1000 for an electric vehicle according to the present disclosure can heat fluid for raising the temperature of the battery. The heating device 1000 can prevent battery performance from deteriorating when the outside air temperature of the electric vehicle becomes low. In addition, the heating device 1000 is provided with the overheating prevention unit 300 capable of preventing overheating that may occur while heating the fluid F, thereby preventing defects caused by overheating.

Accordingly, the present disclosure has the effect of blocking power to the heater based on the exact temperature of the heater by arranging the overheating prevention means close to the heater to minimize the influence of the fluid located between the heater and the overheating prevention means.

The embodiments of the present disclosure described above and shown in the drawings should not be construed as limiting the technical idea of the present disclosure. The scope of protection of the present disclosure is limited only by the matters described in the claims, and a person of ordinary skill in the art can make various improvements and modifications to the technical idea of the present disclosure. Therefore, such improvements and modifications will fall within the scope of protection of the present disclosure as long as they are obvious to the person of ordinary skill in the art.

What is claimed is:

1. A fluid heating device for an electric vehicle, the device comprising:
a housing forming a first space in which a fluid is introduced and heated, and a second space separated from the first space by a partition wall formed therein;
a heater that extends from an outside of the housing into the first space to form a path through which the fluid flows into the first space and heats the fluid;
a plate provided on the partition wall between the first space and the second space to be close to the heater; and
an overheating prevention unit provided on a side of the plate facing the second space and blocking power provided to the heater when heat applied from the heater reaches a preset range.

2. The fluid heating device of claim 1, wherein the plate brings the overheating prevention unit closer to the heater than the partition wall.

3. The fluid heating device of claim 2, wherein the plate includes:
a support member contacting one surface of the partition wall in the second space;
a connecting member extending from the support member to the first space; and
a mounting member provided to the connecting member, wherein a surface of the mounting member facing the heater is closer to the heater than the partition wall, and the overheating prevention unit is mounted on the mounting member,
wherein the plate blocks fluid communication between the first space and the second space.

4. The fluid heating device of claim 3, wherein the housing includes:
a first outer wall extending from the partition wall; and
a first cover member coupled to the first outer wall to close the second space, and
wherein the first cover member includes a plate pressing body that is coupled to the first outer wall to press the support member against the partition wall.

5. The fluid heating device of claim 4, further comprising a ground screw extending through the first cover member into the second space,
wherein the ground screw includes:
a head member exposed to an outside of the first cover member and connected to a ground wire; and
a thread member extending from the head member, penetrating the first cover member, and contacting a wiring disposed in the second space, and
wherein a sealing member is provided between the first cover member and the thread member.

6. The fluid heating device of claim 1, wherein the heater includes:
a tube member including a first tube through which the fluid flows in, and a second tube provided to surround the first tube;
a heating member provided between the first tube and the second tube to generate heat; and
a heater support member extending from an outer periphery of the tube member to come in surface contact with the housing.

7. The fluid heating device of claim 6, wherein the housing includes a second cover member supporting the heater to the housing, and
the second cover member includes a heater pressing body that presses the heater support member against the housing.

8. The fluid heating device of claim 7, wherein the housing includes a second outer wall which extends from one surface of the housing and one end of which extends outward, and
the second cover member includes a locking protrusion formed at an edge of a surface where the second outer wall is in contact to surround one end of the second outer wall.

9. The fluid heating device of claim 8, wherein the housing includes a coupling member that surrounds an outer surface of an end of the second outer wall and an outer surface of the locking protrusion when the end of the second outer wall and the locking protrusion are coupled to each other.

10. The fluid heating device of claim 6, wherein the tube member includes a heater outlet through which the fluid flows out into the first space, and
the housing is formed such that an outlet through which the fluid flows out is located at a position where the distance between the heater outlet and the outlet is maximized.

11. The fluid heating device of claim 6, wherein the tube member is made of ceramic material, and
wherein when the heating member generates heat exceeding a preset temperature, at least one of the first tube and the second tube breaks to prevent overheating of the heating member.

12. The fluid heating device of claim 1, further comprising a temperature sensor installed in the housing to measure a temperature of the fluid in the first space, wherein the housing includes:
a sensor fastening member in communication with the first space to which the temperature sensor is fastened, and
a separation prevention member connected to an outer end of the temperature sensor and the sensor fastening member to prevent the temperature sensor from being separated from the sensor fastening member.
